(19) United States
(12) Patent Application Publication
(10) Pub. No.: US 2002/0146365 A1
(43) Pub. Date: Oct. 10, 2002

(54) Method for the preparation of oxide powders

(76) Inventors: Woo-Seok Cho, Suwon-si (KR); Tae-Wan Kim, Seoul (KR)

Correspondence Address: David A. Einhorn, Esq., Anderson Kill & Olick, P.C., 1251 Avenue of the Americas, New York, NY, 10020, US

(21) Appl. No.: 10/109,969

(22) Filed: Mar. 29, 2002

(30) Foreign Application Priority Data
Apr. 9, 2001 (KR) 2001-18567

(51) Int. Cl. C01G 23/04

(52) U.S. Cl. 423/598; 423/263; 423/608

(57) ABSTRACT

A highly pure oxide powder can be prepared by a simple process comprising hydrothermally reacting oxide precursors in the presence of a metal complex-forming ligand.

### FIELD OF THE INVENTION

The present invention relates to a high-yield method for preparing a submicron oxide powder of high purity by way of conducting a hydrothermal reaction of oxide precursors in the presence of a metal complex-forming compound.

### BACKGROUND OF THE INVENTION

Ultrapure oxide powders are required in the production of multiplayer ceramic capacitor (MLCC) chips for next-generation digital devices and ultrahigh frequency communication equipments such as IMT-2000; filters; and other electronic parts. Such oxide powders used in the manufacture of high capacity MLCC chips are commercially available, e.g., from Sakai Chemicals, Japan, and they are generally synthesized by hydrothermally reacting a hydroxide of Sr, Ba or Pb with a hydroxide or peroxide of Ti, Zr or Hf.

This method, however, is hampered by the problem that Sr, Ba or Pb ion in solution rapidly reacts with dissolved carbonate ions to form an insoluble carbonate, e.g., BaCO₃, which contaminates the desired oxide powder and gives an oxide having a composition that deviates from the intended stoichiometric atomic ratio, thereby providing poor electrical properties. Thus, in order to obtain a pure, stoichiometric oxide powder, a post-treatment process is used, as disclosed in, e.g., Japanese Patent Nos. 86-31345 and 88-144115, which comprises washing a hydrothermally synthesized powder thoroughly to remove carbonate contaminants, determining the element ratio of the washed powder by X-ray fluorescence analysis, adding a deficient element, e.g., Sr, Ba or Pb to the powder, and then wet mixing. A schematic processing diagram of this conventional method of preparing a barium titanate powder is shown in FIG. 1. This multi-step process is extremely complicated and hampered by a high manufacture cost and poor product quality.

U.S. Pat. No. 6,129,903, filed by Cabot Corporation, discloses a method of preparing a barium titanate powder by hydrothermally reacting a hydrated titanium oxide gel and barium hydroxide. This method also suffers from the problem of carbonate contaminant formation and the preparation of a pure titanium oxide gel requires complicated process steps.

### SUMMARY OF THE INVENTION

Accordingly, it is an object of the present invention to provide an effective and simple method for preparing a submicron oxide powder of high purity.

In accordance with one aspect of the present invention, there is provided a method for preparing an oxide powder, which comprises hydrothermally reacting (1) at least one first material selected from the group consisting of chlorides, nitrates, acetates, hydroxides and hydrates of the elements, Ca, Sr, Ba, Mg, La and Pb, and (2) at least one second material selected from the group consisting of alkoxides, oxides, halogenides, nitrates, sulfates, and hydrolyates of the elements, Ti, Zr, Hf and Ce, in the presence of (3) a metal complex-forming ligand.

### BRIEF DESCRIPTION OF THE DRAWINGS

The above and other objects and features of the present invention will become apparent from the following description of the invention, when taken in conjunction with the accompanying drawings, which respectively show:

FIG. 1: a schematic processing diagram for the preparation of a barium titanate powder in accordance with the conventional method;

FIG. 2: a schematic processing diagram for the preparation of a barium titanate powder in accordance with the inventive method;

FIGS. 3 and 4: X-Ray Diffraction (XRD) pattern and Scanning Electron Microscope (SEM) photograph of the barium titanate powder prepared in Example 1; and

FIGS. 5 to 7: XRD patterns of the barium titanate powders prepared in Examples 2 and 3, and Comparative Example.

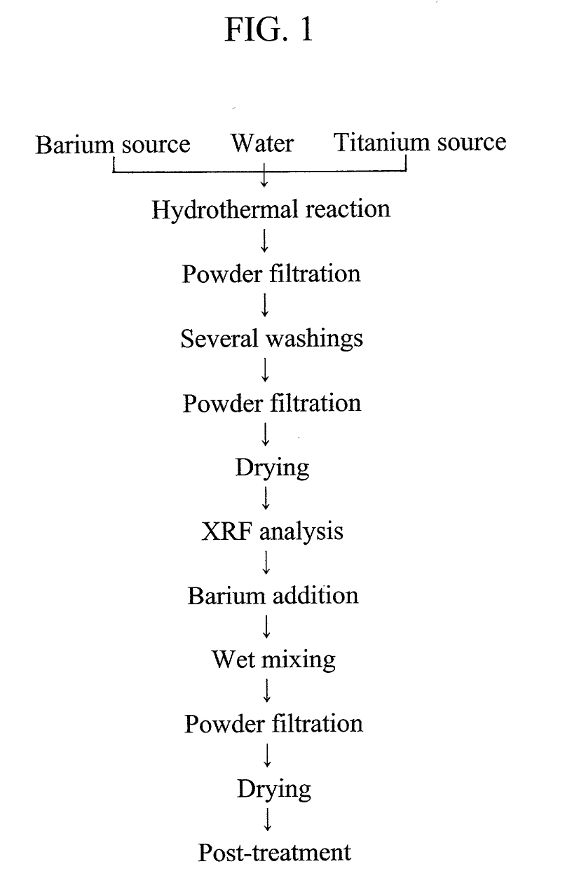

### DETAILED DESCRIPTION OF THE INVENTION

The method of the present invention comprises conducting a hydrothermal reaction of (1) a reactant, a first material and (2) another reactant, a second material, in the presence of (3) a metal-complex forming ligand.

In the hydrothermal process of the present invention, the second material may be used in an amount ranging from 0.1 to 10 equivalents based on the amount of the first material.

A metal complex-forming ligand used in the present invention may have one or more amino or carboxyl groups which is capable of forming a complex with a metal ion of the first material. Such a complex tends to very slowly react with carbonate ions in solution, but the complex would readily react with the second material under a hydrothermal condition, to provide a desired oxide in a highly pure form. Representative examples of the inventive metal complex-forming ligand include EDTA (ethylenediamine tetracetic acid), NTA (nitrotriacetic acid), DCTA (trans-1,2-diaminocyclohexanetetracetic acid), DTPA (diethylenetriamine pentacetic acid), EGTA (bis-(aminoethyl)glycol ether-N,N,N′,N′-tetracetic acid), PDTA (propylenediamine tetracetic acid), BDTA (2,3-diaminobutane-N,N,N′,N′-tetracetic acid), and derivatives thereof, and it may be used in an amount of 1 equivalent or less based on the amount of the first material.

In addition, if necessary, a base may be further added to the reaction solution to pH 9 to 14. Since chlorides, nitrates, acetates, or hydroxides or hydrates of Mg, La or Pb generally have low solubilities in water, the addition of such a base is preferred when said compound is used as the first material. A base such as a quaternary ammonium hydroxide, ammonia, an amine, and a mixture thereof may be used in an amount ranging from 3 to 25% by weight based on the weight of water.

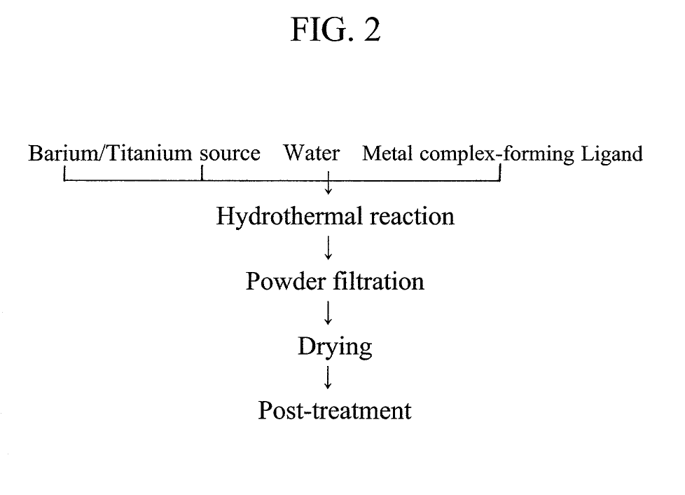

In accordance with the overall hydrothermal process of the present invention, the first material, the second material, the metal complex-forming ligand and the optional base are mixed with water in appropriate amounts, the mixture is maintained at 40 to 300° C., and then, the reaction product is filtered and dried to obtain submicron crystals of an oxide powder. A schematic diagram of the inventive process for preparing a barium titanate powder is shown in FIG. 2.

When the inventive hydrothermal process is conducted at a temperature of below 100° C., it is possible to continuously produce a desired product using a continuous reactor system, but the reaction time may become disadvantageously long. To complete the reaction at 100° C. or more, it takes several minutes to several hours. Further, if necessary, the filtered and dried reaction product may be subjected to a post-treatment such as pulverization.

The oxide powder prepared by the inventive method has a right stoichiometric atomic ratio, contains no contaminants, and has a particle size ranging from 20 nm to 1 μm.

As described above, the present invention provides for the first time a simple and economical method for preparing a highly pure, submicron oxide powder having a narrow particle size distribution in high yield.

The following Examples and Comparative Example are given for the purpose of illustration only, and are not intended to limit the scope of the invention.

### EXAMPLE 1

### Preparation of a BaTiO₃ Powder

2.04 mol of titanium tertrachloride, 2.04 mol of barium chloride, 175 g of tetramethylammonium hydroxide and 0.53 mol of EDTA were mixed with 700 g of ultrapure distilled water in a hydrothermal reactor vessel, and kept at 150° C. for 2 hours. The precipitated product was centrifuged and dried in a 150° C. oven to obtain 460 g of a BaTiO₃ powder (yield: 97%).

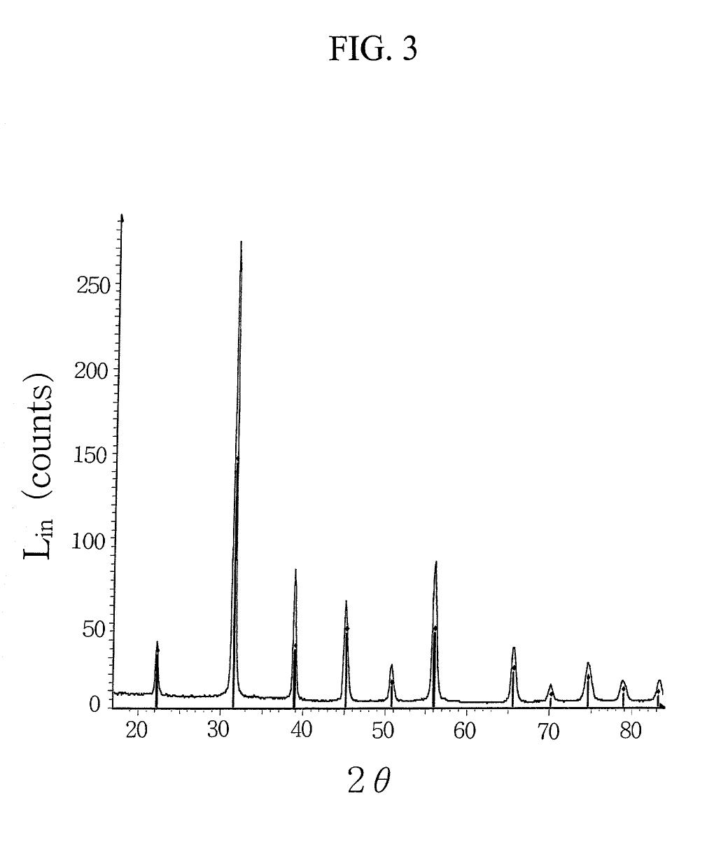

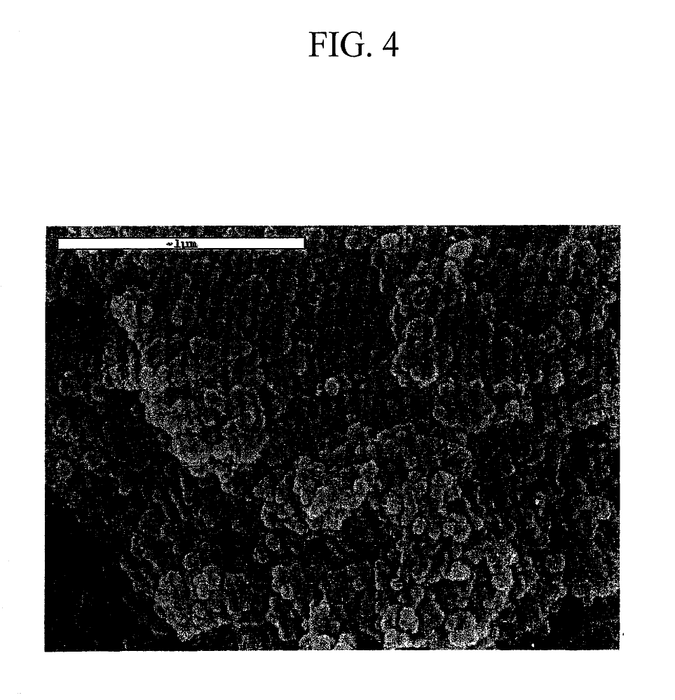

X-Ray Diffraction (XRD) pattern and Scanning Electron Microscope (SEM) photograph of the BaTiO₃ powder thus obtained are shown in FIGS. 3 and 4, respectively. In FIG. 3, peaks for contaminant BaCO₃ or unreacted starting materials are not detected, suggesting that the source materials cleanly converted into highly pure crystalline BaTiO₃. Analysis of the peaks in FIG. 4 shows that the particle size of the powder is in the range of 100 to 500 nm, and the particle size distribution is very narrow. In addition, an X-ray Fluorescence (XRF) spectrum thereof showed that the Ba/Ti atomic ratio was 1.0002, thereby confirming that a stoichiometric BaTiO₃ powder was indeed obtained.

### EXAMPLE 2

### Preparation of a BaTiO₃ Powder

The procedure of Example 1 was repeated except that 0.35 mol of titanium tertraisopropoxide, 0.35 mol of barium hydroxide and 0.09 mol of EDTA were used, to obtain 65 g of a BaTiO₃ powder (yield: 80%).

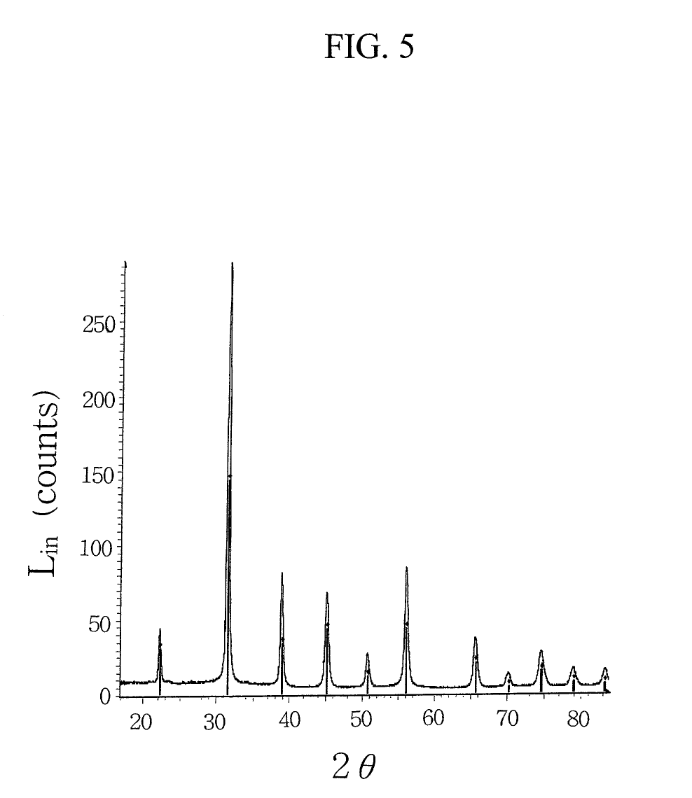

An XRD spectrum of the BaTiO₃ powder thus obtained is shown in FIG. 5, wherein peaks for contaminant BaCO₃ or unreacted starting materials are not detected, suggesting that the source materials cleanly converted into highly pure crystalline BaTiO₃. An SEM photograph of the powder shows that the particle size and particle size distribution thereof are similar to those of Example 1. In addition, an XRF spectrum thereof showed that the Ba/Ti atomic ratio was 1.0005, thereby confirming that a stoichiometric BaTiO₃ powder was indeed obtained.

### EXAMPLE 3

### Preparation of a BaTiO₃ Powder

The procedure of Example 1 was repeated except that 0.76 mol of titanium tertraethoxide, 0.76 mol of barium nitrate, 175 g of tetramethylammonium hydroxide and 0.19 mol of EDTA were used, to obtain 163 g of a BaTiO₃ powder (yield: 92%).

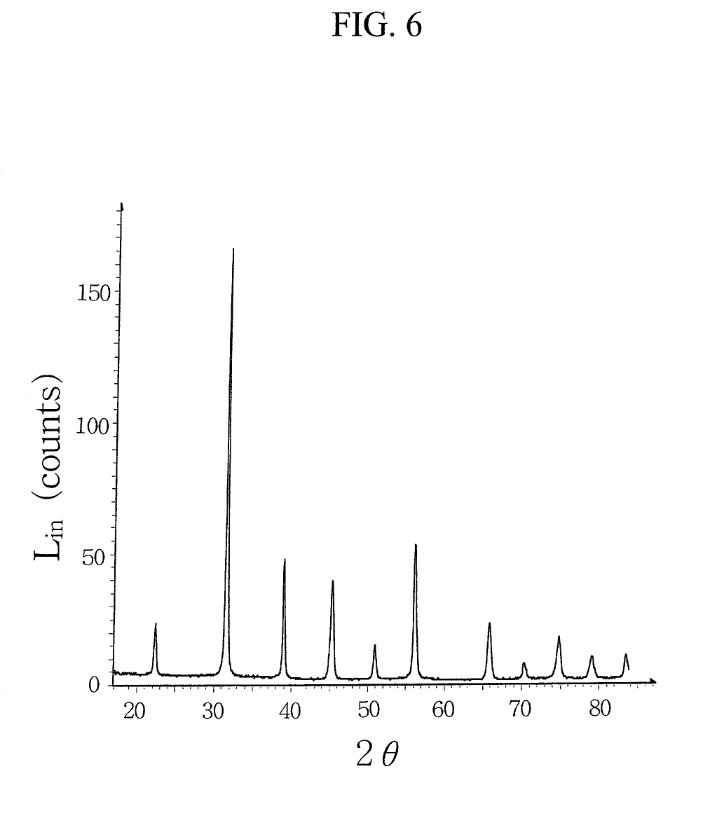

An XRD spectrum of the BaTiO₃ powder thus obtained is shown in FIG. 6, wherein peaks for contaminant BaCO₃ or unreacted starting materials are not detected, suggesting that the source materials cleanly converted into highly pure crystalline BaTiO₃. An SEM photograph of the powder shows that the particle size and particle size distribution thereof are similar to those of Example 1. In addition, an XRF spectrum thereof showed that the Ba/Ti atomic ratio was 1.0001, thereby confirming that a stoichiometric BaTiO₃ powder was indeed obtained.

### EXAMPLE 4

### Preparation of a CaZrO₃ Powder

0.21 mol of Ca(OH)₂, 0.21 mol of ZrO(NO₃)₂.xH₂O, 175 g of tetraethylammonium hydroxide, 0.023 mol of EGTA and 0.022 mol of DCTA were mixed with 700 g of ultrapure distilled water in a hydrothermal reactor vessel, and kept at 170° C. for 2 hours. The precipitated product was centrifuged and dried in a 150° C. oven to obtain 33 g of a CaZrO₃ powder (yield: 89%).

An XRD spectrum of the CaZrO₃ powder thus obtained shows that peaks for contaminant CaCO₃ or unreacted starting materials are not detected, suggesting that the source materials cleanly converted into highly pure crystalline CaZrO₃. An SEM photograph of the powder shows that the particle size and particle size distribution thereof are similar to those of Example 1. In addition, an XRF spectrum thereof showed that the Ca/Zr atomic ratio was 1.0011, thereby confirming that a stoichiometric CaZrO₃ powder was indeed obtained.

### EXAMPLE 5

### Preparation of a SrTi_{0.9}Hf_{0.1}O₃ Powder

0.34 mol of Sr(OH)₂. 6H₂O, 0.306 mol of H₄TiO₃, 0.034 mol of Hf(SO₄)₂, 49 g of pyridine, 21 g of methylamine, 105 g of tetrapropylammonium hydroxide and 0.95 mol of PDTA were mixed with 700 g of ultrapure distilled water in a hydrothermal reactor vessel, and kept at 165° C. for 2 hours. The precipitated product was centrifuged and dried in a 150° C. oven to obtain 62 g of a SrTi_{0.9}Hf_{0.1}O₃ powder (yield: 94%).

An XRD spectrum of the SrTi_{0.9}Hf_{0.1}O₃ powder thus obtained shows that peaks for contaminant strontium carbonate or unreacted starting materials are not detected, suggesting that the source materials cleanly converted into highly pure crystalline SrTi_{0.9}Hf_{0.1}O₃. An SEM photograph of the powder shows that the particle size and particle size distribution thereof are similar to those of Example 1. In addition, an XRF spectrum thereof showed that the Sr:Ti:Hf atomic ratio was 1.000:0.8999:0.1001, thereby confirming that a stoichiometric SrTi_{0.9}Hf_{0.1}O₃ powder was indeed obtained.

### EXAMPLE 6

### Preparation of a MgTiO₃ Powder

0.42 mol of Mg(OH)₂, 0.42 mol of Ti(OCH₂CH₂CH₃)₄, 70 g of triethylamine, 105 g of tetrabutylammonium hydroxide, 0.052 mol of BDTA and 0.052 mol of NTA were mixed with 700 g of ultrapure distilled water in a hydrothermal reactor vessel, and kept at 155° C. for 2 hours. The precipitated product was centrifuged and dried in a 150° C. oven to obtain 47 g of a MgTiO₃ powder (yield: 93%).

An XRD spectrum of the MgTiO₃ powder thus obtained shows that peaks for contaminant magnesium carbonate or unreacted starting materials are not detected, suggesting that the source materials cleanly converted into highly pure crystalline MgTiO₃. An SEM photograph of the powder shows that the particle size and particle size distribution thereof are similar to those of Example 1. In addition, an XRF spectrum thereof showed that the Mg/Ti atomic ratio was 1.0004, thereby confirming that a stoichiometric MgTiO₃ powder was indeed obtained.

### EXAMPLE 7

### Preparation of a Sr_{0.8}Ca_{0.2}Ti_{0.7}Zr_{0.3}O₃ Powder

0.304 mol of Sr(CH₃CO₂)₂, 0.076 mol of Ca(OH)₂, 0.266 mol of TiCl₄, 0.114 mol of ZrOCl₂, 175 g of tetraethylammonium hydroxide and 0.152 mol of DCTA were mixed with 700 g of ultrapure distilled water in a hydrothermal reactor vessel, and kept at 165° C. for 2 hours. The precipitated product was centrifuged and dried in a 150° C. oven to obtain 65 g of a Sr_{0.8}Ca_{0.2}Ti_{0.7}Zr_{0.3}O₃ powder (yield: 92%).

An XRD spectrum of the Sr_{0.8}Ca_{0.2}Ti_{0.7}Zr_{0.3}O₃ powder thus obtained shows that peaks for contaminant strontium carbonate and calcium carbonate or unreacted starting materials are not detected, suggesting that the source materials cleanly converted into highly pure crystalline Sr_{0.8}Ca_{0.2}Ti_{0.7}Zr_{0.3}O₃. An SEM photograph of the powder shows that the particle size and particle size distribution thereof are similar to those of Example 1. In addition, an XRF spectrum thereof showed that the Sr:Ca:Ti:Zr atomic ratio was 0.8001:0.1999:0.7001:0.3002, thereby confirming that a stoichiometric Sr_{0.8}Ca_{0.2}Ti_{0.7}Zr_{0.3}O₃ powder was indeed obtained.

### EXAMPLE 8

### Preparation of a Ba_{0.8}Pb_{0.2}Ti_{0.9}Ce_{0.1}O₃ Powder

0.304 mol of Ba(CH₃CO₂)₂, 0.076 mol of Pb(OH)₂, 0.342 mol of TiO₂, 0.038 mol of Ce(NO₃)₃.6H₂O, 63 g of tetramethylammonium hydroxide, 70 g of tetrabutylammonium hydroxide, 42 g of ammonia and 0.095 mol of DTPA were mixed with 700 g of ultrapure distilled water in a hydrothermal reactor vessel, and kept at 170° C. for 2 hours. The precipitated product was centrifuged and dried in a 150° C. oven to obtain 89 g of a Ba_{0.8}Pb_{0.2}Ti_{0.9}Ce_{0.1}O₃ powder (yield: 93%).

An XRD spectrum of the Ba_{0.8}Pb_{0.2}TiO_{0.9}Ce_{0.1}O₃ powder thus obtained shows that peaks for contaminant barium carbonate and lead carbonate or unreacted starting materials are not detected, suggesting that the source materials cleanly converted into highly pure crystalline Ba_{0.8}Pb_{0.2}Ti_{0.9}Ce_{0.1}O₃. An SEM photograph of the powder shows that the particle size and particle size distribution thereof are similar to those of Example 1. In addition, an XRF spectrum thereof showed that the Ba:Pb:Ti:Ce atomic ratio was 0.8001:0.2001:0.9002:0.1003, thereby confirming that a stoichiometric Ba_{0.8}Pb_{0.2}Ti_{0.9}Ce_{0.1}O₃ powder was indeed obtained.

### EXAMPLE 9

### Preparation of a Ba_{0.9}Ca_{0.1}Ti_{0.7}Zr_{0.3}O₃ Powder

0.396 mol of BaCl₂.2H₂O, 0.044 mol of Ca(OH)₂, 0.308 mol of TiCl₄, 0.132 mol of ZrOCl₂, 126 g of tetrapropylammonium hydroxide, 49 g of triethylamine, 0.07 mol of EDTA and 0.04 mol of NTA were mixed with 700 g of ultrapure distilled water in a hydrothermal reactor vessel, and kept at 170° C. for 2 hours. The precipitated product was centrifuged and dried in a 150° C. oven to obtain 95 g of a Ba_{0.9}Ca_{0.1}Ti_{0.7}Zr_{0.3}O₃ powder (yield: 91%).

An XRD spectrum of the Ba_{0.9}Ca_{0.1}Ti_{0.7}Zr_{0.3}O₃ powder thus obtained shows that peaks for contaminant barium carbonate and calcium carbonate or unreacted starting materials are not detected, suggesting that the source materials cleanly converted into highly pure crystalline Ba_{0.9}Ca_{0.1}Ti_{0.7}Zr_{0.3}O₃. An SEM photograph of the powder shows that the particle size and particle size distribution thereof are similar to those of Example 1. In addition, an XRF spectrum thereof showed that the Ba:Ca:Ti:Zr atomic ratio was 0.9002:0.1005:0.7006:0.3009, thereby confirming that a stoichiometric Ba_{0.9}Ca_{0.1}Ti_{0.7}Zr_{0.3}O₃ powder was indeed obtained.

### COMPARATIVE EXAMPLE

### Preparation of a BaTiO₃ Powder

0.22 mol of titanium chloride and 0.22 mol of barium hydroxide were mixed with 700 g of ultrapure distilled water in a hydrothermal reactor vessel, and kept at 150° C. for 2 hours. The precipitated product was centrifuged and dried in a 150° C. oven to obtain 37 g of a BaTiO₃ powder (yield: 72%).

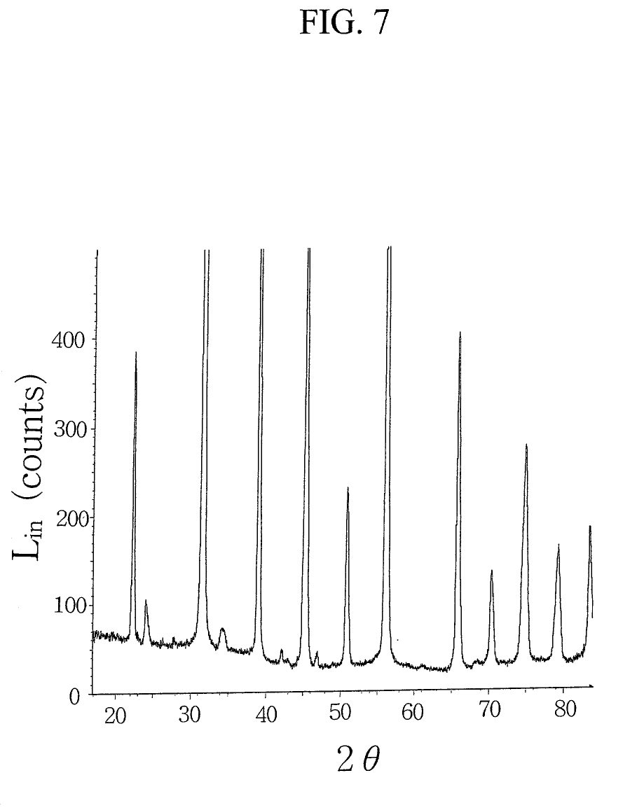

An XRD spectrum of the BaTiO₃ powder thus obtained is shown in FIG. 7, wherein peaks for contaminant BaCO₃ are observed, suggesting that a portion of the barium source material underwent a side reaction. In addition, an XRF spectrum thereof showed that the Ba/Ti atomic ratio was 0.9652, thereby confirming that the powder obtained was not pure BaTiO₃.

As described above, in accordance with the method of the present invention, submicron oxide powders which have very narrow particle size distribution may be simply synthesized in high purity and high yield.

While the invention has been described with respect to the above specific embodiments, it should be recognized that various modifications and changes may be made to the invention by those skilled in the art which also fall within the scope of the invention as defined by the appended claims.

What is claimed is:

1. A method for preparing an oxide powder, which comprises hydrothermally reacting (1) at least one first material selected from the group consisting of chlorides, nitrates, acetates, hydroxides and hydrates of the elements, Ca, Sr, Ba, Mg, La and Pb, and (2) at least one second material selected from the group consisting of alkoxides, oxides, halogenides, nitrates, sulfates and hydrolyates of the elements, Ti, Zr, Hf and Ce, in the presence of (3) a metal complex-forming ligand.

2. The method of claim 1, wherein the hydrothermal reaction is conducted in water with a base further added to the reaction mixture, the base being selected from the group consisting of a quaternary ammonium hydroxide, ammonia, an amine, and a mixture thereof.

3. The method of claim 1, wherein the metal complex-forming ligand is a compound which has an amino or carboxyl group and is capable of forming a complex with a metal ion of the firtst material.

4. The method of claim 3, wherein the metal complex-forming ligand is selected from the group consisting of EDTA (ethylenediamine tetracetic acid), NTA (nitrotriacetic acid), DCTA (trans-1,2-diaminocyclohexanetetracetic acid), DTPA (diethylenetriamine pentacetic acid), EGTA (bis-(aminoethyl)glycol ether-N,N,N′,N′-tetracetic acid), PDTA (propylenediamine tetracetic acid), BDTA (2,3-diaminobutane-N,N,N′,N′-tetracetic acid), and derivatives thereof.

5. The method of claim 1, wherein the second material is used in an amount ranging from 0.1 to 10 equivalents based on the amount of the first material.

6. The method of claim 1, wherein the hydrothermal reaction is conducted at a temperature ranging from 40 to 300° C.

7. An oxide powder prepared by the method of any one of claims 1 to 6.

8. The oxide powder of claim 7, which has a particle size ranging from 20 nm to 1 μm.
